(19) United States
(12) Patent Application Publication
(10) Pub. No.: US 2004/0042508 A1
(43) Pub. Date: Mar. 4, 2004

(54) Method for rapidly allocating radio resources to logical channels in a down-link direction

(76) Inventor: Christian Menzel, Maisach (DE)

Correspondence Address: STAAS & HALSEY LLP, SUITE 700, 1201 NEW YORK AVENUE, N.W., WASHINGTON, DC, 20005, US

(21) Appl. No.: 10/332,963

(22) PCT Filed: Jul. 11, 2001
(86) PCT No.: PCT/DE01/02581

(30) Foreign Application Priority Data
Jul. 14, 2000 (DE) 100 34 248.5

(51) Int. Cl. H04J 3/12

(52) U.S. Cl. 370/522

(57) ABSTRACT

A station manages the resources of a transmission channel to another station registered there in an operating mode in which the transmission channel is shared. Transmission information on the data that are to be consecutively transmitted is transmitted in a message block of information items to the registered station prior to the transmission of the data without requiring transmission of a complete message block to allocate resources before every data transmission. Identification information characterizing the data to be transmitted is included in the message block and data transmission is then announced in a signaling channel by transmitting the identification information prior to data transmission.

The invention relates to a a method for rapidly allocating radio resources to logical connection-oriented channels in a data transmission in a downlink direction and to a base station and a radio station for carrying out the method.

In radio communication systems, information, for example voice, picture information or other data, is transmitted with the aid of electromagnetic waves via a radio interface between transmitting and receiving station (base station and subscriber station, respectively). The electromagnetic waves are radiated at carrier frequencies which are within the frequency band provided for the respective system. For future mobile radio systems with CDMA or TD/CDMA transmission methods via the radio interface, for example the UMTS (Universal Mobile Telecommunication System) or other 3rd generation systems, frequencies are provided in the frequency band of approx. 2000 MHz.

In the future, so-called real-time data are to be transmitted via packet-oriented connections, especially for voice transmissions, both in the currently used GSM (Global System for Mobile Communication) standard and in the UMTS or UTRAN (Universal Terrestrial Radio Access Network) standard with TDD (Time Division Duplex) and FDD (Frequency Division Duplex) transmission modes. Real-time data are understood to be data which are impaired as little as possible by propagation delays, cut-off losses or the like. This necessitates that, as a rule, such real-time data services have to have priority over non-realtime data services during the transmission via the air interface. For the transmission of non-realtime data, in particular, the transmission gaps of the real-time data services are available. In particular, this requires the capability of transmitting the non-realtime data in a well-organized and resource-preserving manner.

Non-realtime data are, e.g., the typical Internet traffic with World-Wide-Web applications, file transmission protocols (FTP) and E-mail. The transmission of non-realtime data via the radio interface, e.g. of a mobile radio system, consists of a multiplicity of short to very large data packets because of the signaling contained in them and the properties of the payload data to be transmitted. In the transmission of the individual data packets, relatively long pauses can exist between them in some cases and their transmission is not, as a rule, very time-critical. In most cases, delays of some 100 ms or more are acceptable in current systems. At present, allocating one or more dedicated channels, that is to say channels which are permanently assigned for the duration of the registration, for such a connection represents a quite considerable waste of resources because the transmission pauses between the individual transactions are not predictable with respect to their duration and can become very long.

The method currently planned in the TDD mode uses shared channels for these data transmissions which are allocated with a time limit per data packet right from the start. In other words, the capacity of the individual shared channels is in each case divided over a number of registered subscriber stations in a time-limited way. During this allocation period, however, the resources of a shared channel are allocated exclusively and differ from dedicated channels only in the allocation period specified in advance.

Such allocations of shared channels and also of dedicated channels requires very large messages or message blocks which, because of their size, represent a considerable overhead, especially if the packet for which a channel has been allocated is very small. The overhead caused by these allocations can be up to 50% at present in TDD mode.

It is the object of the invention to specify a method in which the system loading for transmissions in downlink directions is reduced.

This object is achieved by the method having the features of patent claim 1, the base station according to the features of patent claim 12 and a radio station for carrying out such a method in accordance with the features of patent claim 13.

The fact that an identification information item for identifying the subsequent transmission of data is reported in the usual message block and that the data transmission is subsequently announced in each case in a signaling channel by sending out the identification information item before the data transmission enables the registered subscriber station to be informed in a resource-saving manner about data subsequently arriving for it on the transmission channel. A first step is the allocation of the identification information item which is unambiguous for a particular registered (subscriber) station. Before later data transmissions, the data to be transmitted then no longer need to be announced with elaborate headers; instead, the previous signaling by means of the identification information item via the signaling channel is sufficient.

The reduction in system loading for transmissions in downlink directions is advantageously achieved in that a number of registered stations really share such shared resources instead of using them only temporarily (for a relatively long term) and at the same time exclusively. Instead of permanently allocating channels for relatively long periods of time, only short blocks are thus allocated for a short term within the channels.

In addition, the data volume to be transmitted and the times of the transmissions no longer need to be known in advance or estimated. This, too, allows system resources to be saved.

Advantageous embodiments are the subject matter of dependent claims.

To report the identification information item during or after the registration process of the subscriber station makes the entire method sequence more efficient. To allocate the identification information item only when the registered station wishes to change over, in contrast, provides for optimization, particularly in the case where certain registered stations are used, e.g. essentially only for voice transmission and only rarely for services in which the use of the method described is needed or is appropriate. In such cases, the registered station can request a request for this particular transmission mode when a service suitable for it is requested. Conversely, the request can also come from the communication network if, e.g., another station wishes to send data to the registered station and these data can be transmitted in a more resource-saving manner by means of the method described.

Due to the fact that the data sent out after the sending out of the identification information item do not contain any special assignment information to the registered station for which they are intended, elaborate signaling and elaborate headers can be omitted.

To use a channel which is physically separate from the transmission channel as the signaling channel enables a channel set up in a simple manner to be set up or also free capacities to be used in signaling channels already set up, or others. In particular, setting up and operation of a special signaling channel requires fewer resources and less expenditure than the respective transmissions of the message blocks known per se for allocating resources. The additional expenditure as a result of the signaling channel needed is clearly less if the proportion of non-realtime data transmissions is correspondingly high, as is assumed for TDD.

To use the identification information item for referring to one or more physical resources of the shared transmission channel provides the possibility of transmitting data about resources which are parallel in time on different channels to a registered station as a result of which the transmission bandwidth and transmission speed can be correspondingly increased compared with a transmission via a single channel.

To allocate the identification information item for a predetermined period of time, particularly some seconds up to some minutes, and also to subdivide it into transmission periods, provides for a uniform distribution to a multiplicity of registered mobile stations and it can be taken into account that in peak periods during the day a larger number of registered stations has to be supplied with data than, e.g., at night time.

To consecutively number at least all downlink resources used for the operating mode with a shared transmission channel provides for an efficient allocation of the identification information via the signaling channel, particularly if it is correspondingly incorporated in the system standard.

In particular, free transmission channels and transmission resources can be rapidly allocated to the registered subscriber stations having different requirements for the quality of service (QoS) and the allocations can be made or changed rapidly. In particular, mixing the data with real-time data can also be implemented in a simple manner.

An application in all conceivable communication systems is advantageously possible in which temporary data transmissions take place in the downlink direction.

In the text which follows, an exemplary embodiment will be explained in greater detail with reference to the drawing, in which:

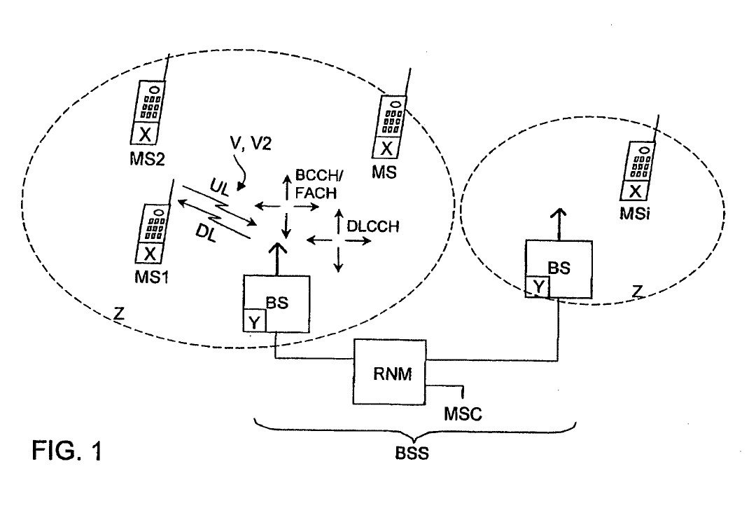

FIG. 1 shows an exemplary radio communication system with two mobile stations communicating with a base station,

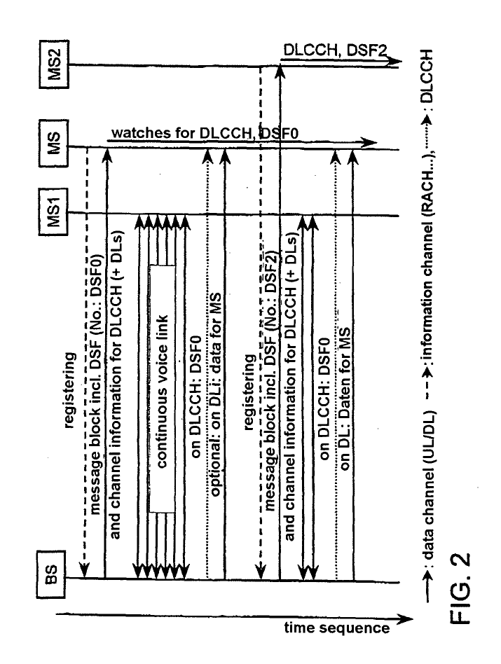

FIG. 2 diagrammatically shows a representation of the sequence of the transmission of signaling information and data, and

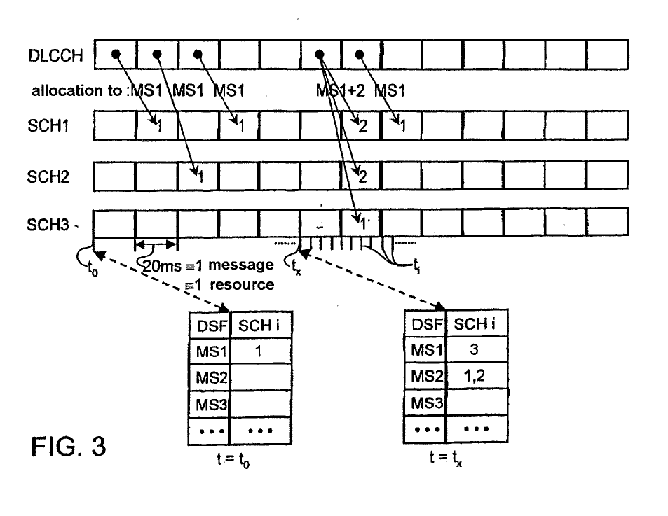

FIG. 3 shows an arrangement for allocating the resources of individual physical channels of a logical channel to different subscriber stations at different times.

The mobile radio system shown in FIG. 1 as an example of a known radio communication system consists of a multiplicity of network elements, particularly of mobile switching centers MSC, facilities RNM for allocating radio resources, base stations BS and, at the lowest hierarchy level, subscriber stations MS.

The mobile switching centers MSC, which are networked together and only one of which is shown here, establish the access to a landline network or to another radio network. Furthermore, these mobile switching centers MSC are connected to in each case at least one of the facilities RNM for allocating radio resources. Each of these facilities RNM, in turn, provides for a connection to at least one base station BS, BS2. Such a base station BS can set up a connection to subscriber stations, e.g. mobile stations MS, MS1 or MS2, respectively, or other mobile and stationary terminals, via a radio interface V and V2, respectively. Each base station BS, BS2 forms at least one radio cell Z. In the case of sectorization or in the case of hierarchical cell structures, a number of radio cells Z are also served for each base station BS, BS2.

FIG. 1 shows by way of example existing connections V, V2 as downlink connections DL and uplink connections UL for transmitting payload information and signaling information between a mobile subscriber station MS, MS1 and MS2, respectively, and the base stations BS and BS2, respectively, correspondingly connected to these. Furthermore, one control channel (FACH or BCCH—broadcast control channel) is in each case shown which is provided for transmitting payload and signaling information with a defined transmitting power from each of the base stations BS and BS2, respectively, for all mobile stations MS and MS2, respectively, in the area of the corresponding radio cell Z.

As can be seen from FIG. 1, at least one downlink control channel (DLCCH) and identification information to be transmitted over this channel in accordance with the method, which are called downlink state flags (DSF) in the text which follows, are introduced in accordance with the exemplary embodiment shown.

A subscriber station MS taken into operation in a cell Z registers in a familiar manner at the responsible base station BS. In doing so, it changes from an inactive state into a standby state in which it can be called up by another telecommunication device via its international subscriber identification number.

According to the present exemplary embodiment, the subscriber station MS is allocated a downlink state flag DSF as soon as the subscriber station MS wishes to change into the downlink mode in a shared-channel mode. This change request can be signaled, e.g. when the subscriber station MS needs and requests a service with a high quality of service (QoS).

As an alternative, however, a downlink state flag can also be generally allocated as soon as a subscriber station MS with the capability for administering a downlink state flag DSF registers at a base station BS which can administer downlink state flags. Allocating a downlink state flag DSF can also take place, e.g., on the initiative of the base station BS if, e.g., a connection with high quality of service is to be set up to the registered subscriber station MS on request by a third-party subscriber station.

This change to the shared-channel mode is signaled, in particular, by the relatively large messages known per se for signaling. In this process, the subscriber station MS is allocated at least one downlink state flag DSF or generally precisely one downlink state flag DSF. This allocation advantageously has a relatively long-term validity of preferably some seconds up to some minutes. A validity of no less than 300 ms duration is particularly advantageous in present systems.

Once the mobile subscriber station MS has changed to the shared-channel mode, it begins to listen permanently on the downlink control channel DLCCH as long as it is in this operating mode. The subscriber station MS has found out about the position of this channel, e.g. in the message initiating or triggering the changeover.

Either all or at least all downlink resources of the radio cell Z used for the shared-channel mode are preferably consecutively numbered. This numbering is reported to the mobile subscriber stations MS which are in the shared-channel mode.

Furthermore, the transmission to the shared channels is advantageously subdivided into transmission periods. These transmission periods can be obtained, e.g., from the interval between successive emissions on the downlink control channel DLCCH in that they are, e.g., equal to this interval or also a multiple of this interval. At present, typical lengths of such transmission periods are 10 ms, 20 ms, 40 ms, 80 ms or 160 ms in the TDD system.

In the downlink control channel DLCCH, assignments between the resource numbers of the shared channels and the downlink state flags DSF which are valid for the subsequent transmission period are now continuously sent out. As can also be seen from FIG. 3, they mean that data are transmitted during the next transmission period in the resource with the number tₓ to the mobile subscriber station MSi, the downlink state flag DSF of which was assigned to the resource number tᵢ of the shared channel. In this arrangement, a so-called logical channel exhibits, among other things, the control channel DLCCH and in this case three shared physical data channels SCH1, SCH2 and SCH3. The data channels are subdivided into timeslots tᵢ and, in the exemplary embodiment shown, four timeslots tₓ each form one message or one message block which can be allocated to a subscriber station MSᵢ as a resource with the resource number tᵢ equal to its first timeslot number tᵢ. For each timeslot tᵢ, one burst each is sent out in, e.g., the TDD system.

Together with the allocation of the downlink state flag DSF to a subscriber station MSi, the information that the subscriber station MSi, after receiving the downlink state flag DSF allocated to it, should always access the data which are subsequently transmitted in a quite particular specified one of the data channels SCHi can also be conveyed to this subscriber station MSi.

Advantageously, however, all resources available as resources tᵢ for shared channels SCHᵢ can be issued in an arbitrary manner to arbitrary stationary or mobile subscriber stations MS which are in the shared-channel mode. The large group produced in this way increases the total throughput, which leads to a “group gain”. This ultimately leads to a more efficient utilization of the radio resources of a cell Z because each resource of a shared channel can be allocated to each of the non-realtime connections and thus no individual “pools per shared channel resource” are formed as happens e.g. in the general packet radio service GPRS defined for the GSM standard.

In addition, it is advantageously also possible to assign a number of resources of a shared channel simultaneously to individual subscriber stations MS during a transmission period when resources of a shared channel SCHi are correspondingly available, and thus correspondingly to increase the transmission bandwidth and speed.

Advantageously, the data volume to be transmitted and the times of the transmissions do not need to be known in advance or estimated since the mechanism described above allows an actual issue of resources on demand in accordance with the availability, the data volume momentarily to be transmitted and other criteria such as e.g. priority or length of the queue of individual data packets.

The signaling overload mentioned above can be reduced by the fact that the extensive allocation message no longer needs to be transmitted for each packet but only once per packet session. This can be of arbitrary length and contain long pauses. In contrast, the additional expenditure by the downlink control channel DLCCH needed is distinctly less if the proportion of transmissions of non-realtime data is correspondingly high as is expected for TDD.

Since allocating a downlink state flag DSF does not yet mean an allocation of an actual resource but only the possibility of rapid resource allocation with little signaling expenditure, a number of downlink state flags DSF can be allocated which is a multiple of the available shared channel resources (“overall location”). This possibility is a particular advantage for packet-like non-realtime data such as are normally used, e.g. in intranet or Internet traffic, because, as a rule, the pauses here are a multiple of the transmission times per packet link and the possible case of simultaneous data transmissions to e.g. all subscriber stations MS can be eliminated by inserting them into queues for a correspondingly long period.

When the numbering of the resources includes not only the resources of the shared channel but all resources of the radio cell Z, it is also possible to mix the data with real-time data. In this arrangement, it is possible to transmit non-realtime data during speech gaps, which can be detected quite simply in the downlink direction by the access network, e.g. base transceiver stations (BTS), instead of the nonexistent voice data, to another subscriber station MS which was informed of this resource via a downlink control channel DLCCH for a transmission period. For the real-time data connection, additional facilities or method sequences are advantageously set up in order to prevent a misdetection of these data.

FIGS. 1 and 2 will now be used to explain an exemplary method sequence. In the area of a base station BS, a first mobile subscriber station MS1 is located which is registered at the base station BS. Between these two stations, there is a voice link, that is to say a real-time data transmission. In the gaps, the base station BS can advantageously also use the transmission channel for communication with other stations.

In such a gap, or via other transmission channels, a communication link is set up to a second mobile subscriber station MS which has registered at the base station BS via the random access channel RACH. The base station BS informs this second subscriber station MS that this or its signaling monitoring device Y should watch out for the signaling DSF0 on the signaling channel DLCCH.

In a later transmission pause in the connection between base station BS and first subscriber station MS1, the base station BS or its signaling and transmitting device Y sends the downlink state flag or signaling information DSF0 via the signaling channel DLCCH which can be received by all subscriber stations MS appropriately equipped. At a predetermined time interval, the base station BS transmits data received in the meantime and temporarily stored for the first subscriber station MS via the data transmission channel DL. The subscriber station MS1 receives and processes these data since it has previously received the signaling information DSF0 allocated to it.

In the exemplary embodiment shown, a third subscriber station MS2 registers at the base station BS in the meantime, the third subscriber station MS2 being allocated the signaling information DSF2. However, the base station BS does not need to transmit data to the third subscriber station MS2 during the period shown.

However, data are again transmitted to the second subscriber station MS at a later time.

In [lacuna] alternative embodiment, a predeterminable period of time can also elapse between the sending-out of the downlink state flag DSF and the transmission of data on a resource specified therein. As a result, corresponding preparations for the data reception about to take place can be made at the receiving station.

FIG. 3 shows an arrangement for allocating the resources of individual physical channels SCH1-SCH3 of a logical channel, which is formed by the totality of the channels, to different subscriber stations at different times tᵢ. The upper row shows the signaling channel DLCCH via which the identification information items are transmitted in a format and/or code which can be received and decoded by all subscriber stations MS1, MS2 registered and capable of the method.

Below this, three so-called physical channels SCH1-SCH3 are shown via which the data are transmitted which are to be received by particular ones of the subscriber stations MS1, MS2.

In the illustration, both the signaling channel DLCCH and the physical channels SCH1-SCH3 are subdivided into sections which in each case have a length of e.g. 20 ms and can be considered to be units of the length of a typical message block or of an allocable resource on the physical channel SCH1-SCH3. Naturally, these resources are not mandatorily restricted to this fixed structure and, in particular, also have a multiplicity of timeslots tᵢ.

In the timing sequence shown, the signaling channel DLCCH informs the first subscriber station MS1 at a first time t₀ shown, with the aid of the signaling or identification information DSF item (MS1,1), that the data of the next resource on the first physical channel SCH1 are intended for this subscriber station MS1.

This is also illustrated in the first table below the channel representation for the time t=t₀. The first column comprises the available codes, in this case MS1, MS2, MS3, . . . , for the identification information item DSF. The second column comprises the assignment information to a particular physical channel SCHi. Thus, it is possible to transmit only the simple identification information item DSF or MS1, MS2, . . . , respectively, in a simple embodiment with only a single physical channel via the signaling channel DLCCH. In the embodiment shown, however, the information about the physical channel on which the data are transmitted which are announced for the particular subscriber station MS1 via the signaling channel DLCCH is also additionally transmitted. This is shown in the second announcement shown in which the first subscriber station MS1 is informed via the signaling channel that data are transmitted for it in the next resource of the second physical channel SCH2. Following this, another transmission in the first channel SCH1 is here announced to the first subscriber station MS1.

This is followed by a pause of two time blocks or resources in which no data are to be transmitted to the registered subscriber stations MS1, . . . from the base station BS with this method.

Following the pause, it is announced via the signaling channel SLCCH at a later time t=tₓ that data are to be transmitted to the first subscriber station MS1 via the third physical channel SCH3 and data are to be transmitted to the second subscriber station MS2 via the first and second physical channel in the next time block.

This is also listed in the second table of FIG. 3 for this later time t=tₓ. In particular, this table also shows that three or more subscriber stations MS1-MS3, . . . are registered at the base station BS at this time for receiving data according to this method even though only three physical channels are available here.

Thus, it is advantageously possible to administer more subscriber stations MSi than resources or physical channels are available. Moreover, it is also possible to transmit data simultaneously via more than one channel SCH1, SCH2 to a subscriber station MS2.

Subscriber stations for carrying out a method described above correspondingly have a device X for storing, administering and recognizing at least the identification information item DSF and, in the ideal case, a software solution utilizing an existing storage area and an existing processor can be implemented.

1. A method for signaling a data transmission from a station (BS) administering resources of a transmission channel (UL, DL) to a station (MS) registered there, in an operating mode with a shared transmission channel (DL),
in which transmission information about data to be subsequently transmitted is transmitted to the registered station (MS) in a message block with a multiplicity of information items before the data transmission, characterized in that
an identification information item (DSF) for identifying the later data transmission is allocated for a particular registered station (MS) in the message block, and in that
subsequently (t₀, tₓ) such a data transmission is in each case announced in a signaling channel (DLCCH) by sending out the identification information item (DSF) before the actual data transmission.

2. The method as claimed in claim 1, in which the identification information item (DSF) is reported to the station (MS) during or after the registration process.

3. The method as claimed in claim 1, in which the identification information item (DSF) is allocated when the registered station (MS) wishes to change over into the method with data transmission after the allocation of the identification information item (DSF).

4. The method as claimed in a preceding claim, in which the data sent out after the sending out of the identification information item (DSF) do not contain any special assignment information to the registered station (MS) for which they are intended.

5. The method as claimed in a preceding claim, in which a channel which is physically separate from the transmission channel (DL) is used as the signaling channel (DLCCH).

6. The method as claimed in a preceding claim, in which a special physical or logical control channel is used as the signaling channel (DLCCH).

7. The method as claimed in a preceding claim, in which the identification information item (DSF) is used for referring to one or more physical resources of the separate transmission channel (SCH1-SCH3).

8. The method as claimed in a preceding claim, in which the identification information item (DSF) is allocated for a predetermined period of time, particularly some seconds up to some minutes and, in particular, is subdivided into transmission periods.

9. The method as claimed in a preceding claim, in which the registered station (MS), after entering into the operating mode with a shared transmission channel, permanently listens to the signaling channel (DLCCH) as long as it is in this operating mode.

10. The method as claimed in a preceding claim, in which at least all downlink resources (SCH1-SCH3) used for the operating mode with a shared transmission channel (DL) are consecutively numbered.

11. The method as claimed in claim 10, in which the numbering is made known in accordance with the standard to the registered stations (MS) which are in the shared-channel mode.

12. A base station (BS) of a radio communication system, particularly for carrying out a method as claimed in a preceding claim, comprising
an administration device in the first station (BS) for administering resources of a transmission channel (UL, DL), and
a signaling device (Y) for signaling a data transmission to at least one second station (MS) in an operating mode with a shared transmission channel (DL), in which transmission information about data to be subsequently transmitted are transmitted to the second station (MS) in a message block with a multiplicity of information items before the data transmission, characterized in that
the signaling device (Y) is constructed for entering an identification information item (DSF) for identifying the transmission of data in the message block before its transmission, and in that
a transmitting device for sending out a signaling channel (DLCCH) with an identification information item (DSF) is set up for the respective signaling of a later transmission of data before the data transmission.

13. A radio station (MS) for data transmission with a base station (BS) as claimed in claim 12 and/or for carrying out a method as claimed in one of claims 1 to 11, comprising
a device (X) for storing, administering and recognizing at least the identification information item (DSF).
